(19) United States
(12) Patent Application Publication
(10) Pub. No.: US 2024/0280078 A1
(43) Pub. Date: Aug. 22, 2024

(54) Drag-Based Wind Turbine Device

(71) Applicants: Angela Xu, San Ramon, CA (US); Annie Xu, San Ramon, CA (US); Albert Xu, San Ramon, CA (US)

(72) Inventors: Angela Xu, San Ramon, CA (US); Annie Xu, San Ramon, CA (US); Albert Xu, San Ramon, CA (US)

(21) Appl. No.: 18/453,452

(22) Filed: Aug. 22, 2023

Related U.S. Application Data
(60) Provisional application No. 63/447,097, filed on Feb. 21, 2023.

(51) Int. Cl. F03D 3/00; F03D 3/02; G09F 23/00

(52) U.S. Cl. CPC F03D 3/009; F03D 3/02; G09F 23/00; F05B 2250/711; F05B 2250/712; F05B 2260/901

(57) ABSTRACT

A drag-based wind turbine device is disclosed. The device is an improved wind turbine comprised of two sets of stacked and coupled, drag-based vertical axis wind turbines, wherein drag from the first turbine helps propel the second turbine. Additionally, the surface of the first turbine is convex to ensure wind is always deflected toward the second turbine, wherein the wind is then received by the concave side of the second turbine. Further, the blades are arranged in a horizontal and sloping manner. In the convex position, each slope blade deflects incoming wind to the other set of turbines in a concave direction. Additionally, the gap between two turbines can be adjusted for different wind/current speeds, viscosities, compressibility, and densities for the best efficiency.

### CROSS-REFERENCE TO RELATED APPLICATION

The present application claims priority to, and the benefit of, U.S. Provisional Application No. 63/447,097, which was filed on Feb. 21, 2023, and is incorporated herein by reference in its entirety.

### FIELD OF THE INVENTION

The present invention relates generally to the field of drag-based wind turbine devices. More specifically, the present invention relates to an improved, more efficient wind turbine to capture wind or tide energy more effectively in areas with variable current directions. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in drag-based wind turbine devices. Generally, drag-based vertical-axis wind turbines have the main rotor shaft arranged vertically. Such wind turbines self-start and do not need to be pointed into the wind to be effective. They are structurally steady and require little maintenance. However, they have lower efficiency compared to lift-based vertical-axis wind turbines and horizontal-axis wind turbines, since there is always half of the turbine producing counterproductive drag.

Although wind power has the potential to provide a large proportion of the world's electricity needs, the variability in the velocity of the wind often makes it an unreliable power source. In particular, this variability makes it difficult to construct wind-driven power-generating devices that are effective and efficient under all wind conditions.

One offered solution for the problem of variable wind velocity has been the vertical axis wind turbine (VAWT). Unlike horizontal axis (propeller-type) windmills, VAWTs pivot about a long vertical axis, such that they may face directly into a wind. A VAWT, therefore, can harness wind energy from large columns of air, making them practical for power generation in low and moderate winds. When combined with features that allow a wind-driven power generator to operate robustly in high winds, a VAWT can be used to generate power in a wide range of wind conditions. There are two types of VAWTs, drag-based and lift-based. Drag-based VAWTs are usually less efficient but simpler, self-starting, and more reliable than lift-based VAWTs. In comparison, horizontal axis wind turbines are most efficient but also most complex and costly compared to left-based VAWTs. Accordingly, there is a demand for an improved vertical axis wind turbine that is a more efficient wind turbine to capture wind energy. More particularly, there is a demand for an efficient drag-based vertical axis wind turbine device that comprises two sets of stacked and coupled, drag-based, vertical axis wind turbines, wherein drag from the first turbine helps to propel the second turbine.

Therefore, there exists a long felt need in the art for a drag-based wind turbine device that provides users with an improved, more efficient wind turbine to capture wind or tide energy more effectively in areas with variable current directions. There is also a long felt need in the art for a drag-based wind turbine device that features two sets of stacked, drag-based vertical axes wind turbines where counterproductive drag from one turbine helps propel the other turbine. Further, there is a long felt need in the art for a drag-based wind turbine device that allows the counterproductive drag from one turbine to always deflect the wind to facilitate rotation of the other turbines. Moreover, there is a long felt need in the art for a device that offers simplicity and structural steadiness compared to regular lift-based vertical axes wind turbines and can be produced at a low cost with minimal maintenance. Further, there is a long felt need in the art for a drag-based wind turbine device wherein the turbines are stacked and coupled and the blades are arranged in a horizontal manner. Finally, there is a long felt need in the art for a drag-based wind turbine device wherein more than one turbine pair can be stacked to the same axis.

The subject matter disclosed and claimed herein, in one embodiment thereof, comprises a drag-based wind turbine device. The device is an improved wind turbine comprised of two sets of stacked and coupled, drag-based vertical axis wind turbines, wherein drag from the first turbine helps propel the second turbine. Further, the gap between turbines may be adjusted as needed for efficiency. Additionally, the surface of the first turbine is convex to ensure wind is always deflected toward the second turbine, wherein the wind is then received by the concave side of the second turbine. Further, the blades are arranged in a horizontal manner. In the convex position, each slope blade deflects incoming wind to the other set of turbines in a concave direction. Additionally, the gap between two turbines can be adjusted for different wind/current speeds, viscosities, compressibility, and densities for the best efficiency. More than one turbine pair can be stacked to the same axis.

In this manner, the drag-based wind turbine device of the present invention accomplishes all of the forgoing objectives and provides users with a device that provides two sets of stacked and coupled vertical axis wind turbines. The device allows the counterproductive drag from one turbine to deflect the wind to facilitate rotation of the other turbines. The device can be produced at a low cost with minimal maintenance.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a drag-based wind turbine device. The device is an improved wind turbine comprised of two sets of stacked and coupled, drag-based vertical axis wind turbines, wherein drag from the first turbine helps propel the second turbine. Additionally, the surface of the first turbine is convex to ensure wind is always deflected toward the second turbine, wherein the wind is then received by the concave side of the second turbine. Further, the blades are arranged in a horizontal manner. In the convex position, each slope blade deflects incoming wind to the other set of turbines in a concave direction.

In one embodiment, the drag-based wind turbine device comprises a set of stacked and coupled, drag-based, vertical axis wind turbines. Each of the wind turbines comprise a main shaft which rotates about a vertical axis. The main shaft is preferably made from steel pipe of sufficient diameter and thickness to withstand compressive, torque and bending loads both during turbine operation and during high winds in which the turbine would be stopped. Attached to the main shaft are a base component with three to four blades. In this embodiment, the device comprises a second base component with three to four blades.

In one embodiment, the number of blades for both base components could change as a design choice although the chord length or rotor diameter would need to change to maintain the desired solidity. However, three-blade is the preferred embodiment. Each blade is attached to the main shaft with a pair of blade arms or mounted to a common disk. The preferred embodiment is to use a disk or two blade arms for each blade, although it is conceivable to use a single blade arm for each blade.

Generally, the width of the turbine is two times the length of a blade. The height of turbine is the total height of all stacked rotors. The wind capture area is the weight times the height. This area is comparable to swept area of horizontal axis wind turbine.

In one embodiment, each of the blades are arranged in a horizontal manner. Thus, each blade comprises a straight surface end and a curved surface end, wherein the curved surface end curves down toward the base component. Generally, each blade is shaped in an inclined sloped semi-circular plane, but can be any suitable shape as is known in the art.

In one embodiment, the main shaft is supported at its lower end in a drive train housing and at its lower end by a bearing. The lower bearing is supported by a set of guy cables. The main shaft extends above the top set of blade arms by a distance that is greater than the length of a blade arm so that the guy cables can be extended at a 45 degree angle to foundations that are buried in the ground. Generally, the embodiment uses three guy cables, although it would be possible to use none, four or more guy cables if desired depending on site soil conditions, topography, and other factors.

In one embodiment, the two base components are mounted face-to-face to the common main shaft, so that they rotate together in opposite directions. Specifically, both the blades would rotate in their concave directions. Accordingly, the surface of the first turbine blades is convex to ensure wind is always deflected toward the second turbine blades, wherein the wind is then received by the concave side of the second turbine. Further, several of such blade-pairs can be staggered, based on the needs and/or wants of a user. By staggering the blade-pairs, the output of the wind turbines can be increased.

In one embodiment, more than one set of two turbines can be included on the same vertical axis.

In use, when the two wind turbines are placed in close proximity to each other, the combination of linear flow and drag from the two turbines combines, such that the efficiency of both turbines is increased. The separation between the two turbines should be kept as small as possible while allowing for appropriate machine and personnel safety. A separation of approximately one to three feet is preferred. This close placement of turbines may be adjusted as needed for efficiency. In the coupled arrangement, the blades of the two turbines should rotate in opposite directions in order to achieve the desired increase in aerodynamic efficiency. Thus, each blade of the first turbine deflects incoming wind to the other set of blades from the second turbine in a concave direction. Specifically, the surface of the first turbine blades are convex to ensure wind is always deflected toward the second turbine blades, wherein the wind is then received by the concave side of the second turbine blades. Accordingly, drag from the first turbine helps propel the second turbine. Further, the gap between the two turbines can be adjusted for different wind/current speeds, viscosities, compressibility, and densities for the best efficiency.

In one embodiment, the wind turbines in the coupled vortex arrangement should be oriented so that the line connecting the centerlines of the two wind turbines is perpendicular to the prevailing energy wind direction.

In one embodiment, the drive train for the wind turbines of the present invention consists of a shaft mounted gearbox that increases the rotational speed of the main shaft to a speed that is useful for driving a generator. A belt drive transfers power from the gearbox to a generator. The belt drive may provide additional speed increases and it also introduces some flexibility into the drive train to smooth out torque spikes. The gearbox is a shaft mounted type that unless restrained will rotate in the direction of the torque. The generator is a standard asynchronous induction generator in the preferred embodiment. Other types of generators or alternators could be used that operate at constant or at variable speeds.

In one embodiment, the drag-based wind turbine device comprises a braking system for braking the device, when needed. The braking system can be any suitable braking system as is known in the art, as long as the braking system must ensure that the wind turbine does not run away to damaging speeds in the event that the electrical grid is lost or that the generator or its controls malfunction and the generator is no longer capable of limiting the speed of the wind turbine rotor. The braking system must also be capable of bringing the wind turbine to a stop in a short period of time in the event of a fault or other problem with the wind turbine. The drag can be reduced to facilitate braking by using removeable slope surface on the blade, like retractable sail.

In one embodiment, the device is made of a lightweight, durable material such as plastic, fiberglass, or the like and manufactured through common extruding and molding processes. Specifically, the drag-based wind turbine device can be manufactured from heat-sealable plastic or polymers, such as polypropylene or acrylonitrile-butadiene-styrene (ABS), or any other suitable material as is known in the art, such as but not limited to, acrylic, polycarbonate, polyethylene, polyethylene terephthalate, polyvinyl chloride, polystyrene, etc. Generally, the device is also manufactured from a material that is water resistant or waterproof, or the base component and blades comprise a coating that is water resistant or waterproof.

In yet another embodiment, the drag-based wind turbine device comprises a plurality of indicia.

In yet another embodiment, a method of efficiently manipulating drag-based wind turbines is disclosed. The method includes the steps of providing a drag-based wind turbine device comprising a set of turbines. The method also comprises stacking the set of turbines on the same axis. Further, the method comprises coupling the set of turbines together, such that drag from the first turbine helps propel the second turbine. Finally, the method comprises positioning the surface of the first turbine in a convex position to ensure wind is always deflected toward the second turbine, where it is received by the concave side of the second turbine.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one embodiment of the drag-based wind turbine device of the present invention showing the device in use in accordance with the disclosed architecture;

FIG. 2 illustrates a perspective view of one embodiment of the drag-based wind turbine device of the present invention showing the set of two vertical axis turbines in accordance with the disclosed architecture;

FIG. 3 illustrates a perspective view of one embodiment of the drag-based wind turbine device of the present invention showing how the device works in accordance with the disclosed architecture; and

FIG. 4 illustrates a flowchart showing the method of efficiently manipulating drag-based wind turbines in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a drag-based wind turbine device that provides users with an improved, more efficient wind turbine to capture wind or tide energy more effectively in areas with variable current directions. There is also a long felt need in the art for a drag-based wind turbine device that features two sets of stacked, drag-based vertical axes wind turbines where counterproductive drag from one turbine helps propel the other turbine. Further, there is a long felt need in the art for a drag-based wind turbine device that allows the counterproductive drag from one turbine to always deflect the wind to facilitate rotation of the other turbines. Moreover, there is a long felt need in the art for a device that offers simplicity and structural steadiness compared to regular drag-based vertical axes wind turbines and can be produced at a low cost with minimal maintenance. Further, there is a long felt need in the art for a drag-based wind turbine device wherein the turbines are stacked and coupled and the blades are arranged in a horizontal manner. Finally, there is a long felt need in the art for a drag-based wind turbine device wherein more than one turbine pair can be stacked to the same axis.

The present invention, in one exemplary embodiment, is a novel drag-based wind turbine device. The device is an improved wind turbine comprised of two sets of stacked and coupled, drag-based vertical axis wind turbines, wherein drag from the first turbine helps propel the second turbine. Additionally, on the drag side of the surface of the first turbine is convex to ensure wind is always deflected toward the second turbine, wherein the wind is then received by the concave side of the second turbine to facilitate the propelling. Further, the blades are arranged in a horizontal manner. In the convex position, each slope blade deflects incoming wind to the other set of turbines in a concave direction. The present invention also includes a novel method of efficiently manipulating drag-based wind turbines. The method includes the steps of providing a drag-based wind turbine device comprising a set of turbines. The method also comprises stacking the set of turbines on the same axis. Further, the method comprises coupling the set of turbines together, such that drag from the first turbine helps propel the second turbine. Finally, the method comprises positioning the surface of the first turbine in a convex position to ensure wind is always deflected toward the second turbine, where it is received by the concave side of the second turbine.

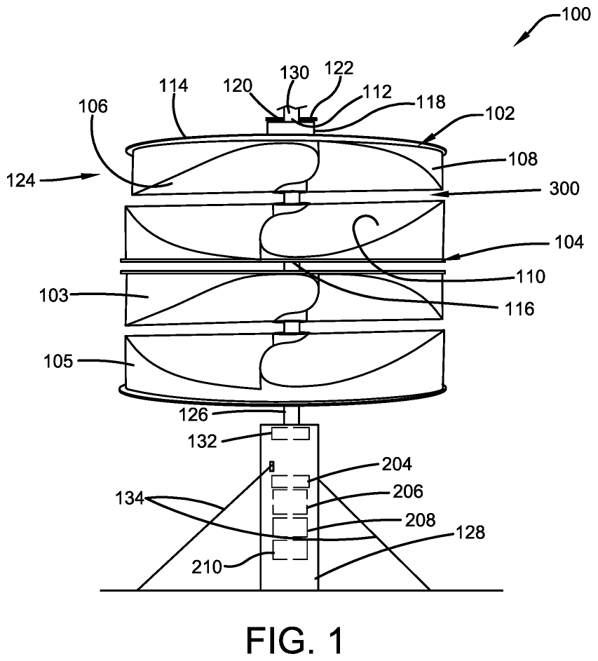

Referring initially to the drawings, FIG. 1 illustrates a perspective view of one embodiment of the drag-based wind turbine device 100 of the present invention. In the present embodiment, the drag-based wind turbine device 100 is an improved drag-based wind turbine device 100 that provides a user with a more efficient wind turbine that captures wind energy more effectively. Further, the device 100 is a set of stacked, and coupled, drag-based vertical axis wind turbines 102 and 104, wherein drag from the first turbine 102 helps propel the second turbine 104. Additionally, the surface 106 of the first turbine 102 is convex to ensure wind is always deflected toward the second turbine 104, wherein the wind is then received by the concave side of the second turbine 104. In the convex position, each slope blade 108 deflects incoming wind to the other set of turbine blades 110 in a concave direction.

As stated supra, the drag-based wind turbine device 100 comprises a set of stacked and coupled, drag-based, vertical axis wind turbines 102 and 104. Each of the wind turbines 102 and 104 comprise a main shaft 112 which rotates about a vertical axis. The main shaft 112 is preferably made from steel pipe of sufficient diameter and thickness to withstand compressive, torque and bending loads both during turbine operations and during high winds in which the turbines 102 and 104 would be stopped. Attached to the main shaft 112 are a base component 114 with three to four blades 108. In this embodiment, the device 100 comprises a second base component 116 with three to four blades 110.

In one embodiment, the number of blades 108 and 110 for both base components 114 and 116 could change as a design choice although the chord length or rotor diameter would need to change to maintain the desired solidity. However, three blades is the preferred embodiment. Each blade 108 and 110 is attached to the main shaft 112 with a pair of blade arms 118 or mounted on a disk. The preferred embodiment is to use two blade arms 118 for each blade 108 and 110, although it is conceivable to use a single blade arm 118 for each blade 108 and 110. It is also preferred that the blade arms 118 be freely attached to each blade 108 and 110 at the ends of the blade 108 and 110 in order to reduce aerodynamic tip effects on the blades 108 and 110 and to avoid blade bending stress at the blade arm attachment point 120. It is preferred that the blade 108 and 110 is attached to the arm 118 with a moment free connection, such as a pinned connection 122.

Generally, in the drag-based wind turbine device 100, the height of the rotor 124 is defined by the length of the blades 108 and 110. The diameter of the rotor 124 is defined by two times the distance from the shaft 112 centerline to the blade 108 and 110 chord line.

Furthermore, the main shaft 112 is supported at its lower end 126 in a drive train housing 128 and at its upper end 130 or lower end by a bearing 132. The upper or lower bearing 132 is supported by a set of guy cables 134. The main shaft 112 extends above the top set of blade arms 118 by a distance that is greater than the length of a blade arm 118 so that the guy cables 134 can be extended at a 45 degree angle to foundations that are buried in the ground. Generally, the embodiment uses three guy cables 134, although it would be possible to use four or more guy cables 134 if desired depending on site soil conditions, topography, and other factors, etc.

Generally, the two base components 114 and 116 are all connected to the common main shaft 112, so that they rotate together. Specifically, the blades 108 of the first base component 114 would rotate in a convex direction, while the blades 110 of the second base component 116 would rotate in a concave direction. Accordingly, the surface 106 of the first turbine blades 108 is convex to ensure wind is always deflected toward the second turbine blades 110, wherein the wind is then received by the concave side of the second turbine 104. Further, the blades 108 and 110 of both the turbines 102 and 104 can be staggered, based on the needs and/or wants of a user. By staggering the blades 108 and 110, the output of the wind turbines 102 and 104 can be smoothed.

In one embodiment, more than one set of two turbines 102 and 104 can be included on the same vertical axis (i.e., main shaft 112). Thus, in one embodiment, there are two sets of two turbines (i.e., set one 102 and 104 and set two 103 and 105), such that four turbines 102, 103, 104, 105 are secured to the main shaft 112, a predetermined distance away from each other, based on the needs and/or wants of a user. Any suitable number of turbines can be utilized on the main shaft 112, depending on the needs and/or wants of a user, and/or the size of the main shaft 112.

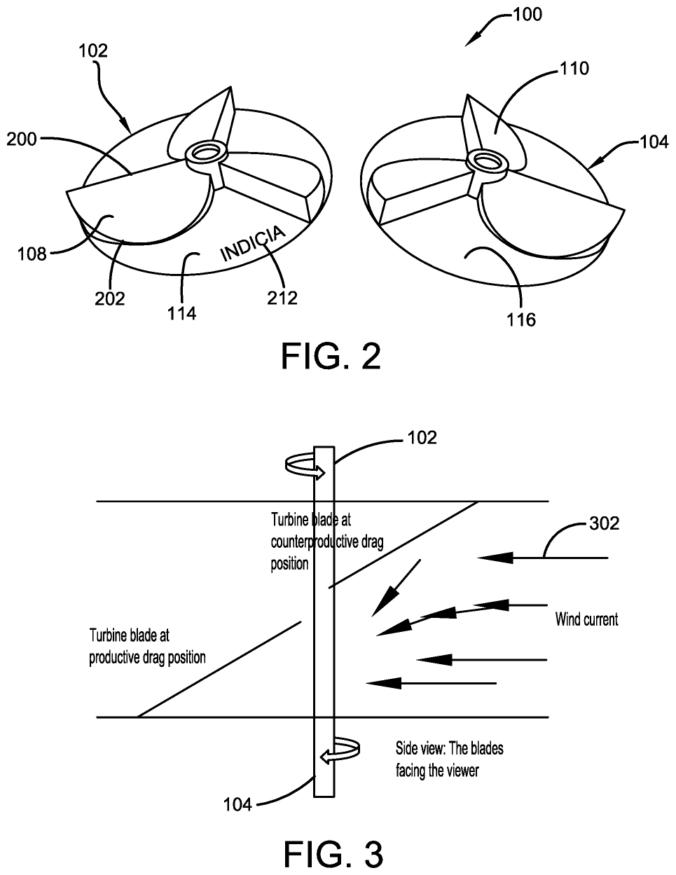

As shown in FIG. 2, each of the blades 108 and 110 are arranged in a horizontal and sloping manner. Thus, each blade 108 and 110 comprises a straight surface end 200 and a curved surface end 202, wherein the curved surface end 202 curves down toward the base component 114 and 116. Generally, each blade 108 and 110 is shaped in an inclined sloped semi-circular plane, but can be any suitable shape and size as is known in the art, depending on the needs and/or wants of a user.

In one embodiment, the drive train 128 for the wind turbines 102 and 104 of the present invention consists of a shaft 112 mounted gearbox 204 that increases the rotational speed of the main shaft 112 to a speed that is useful for driving a generator. A belt drive 206 transfers power from the gearbox 204 to a generator 208. The belt drive 206 may provide additional speed increases and it also introduces some flexibility into the drive train 128 to smooth out torque spikes. The gearbox 204 is a shaft mounted type that unless restrained will rotate in the direction of the torque. The generator 208 is a standard asynchronous induction generator in the preferred embodiment. Other types of generators or alternators could be used that operate at constant or at variable speeds, as is known in the art.

Furthermore, in another embodiment, the drag-based wind turbine device 100 comprises a braking system 210 for braking the device 100, when needed. The braking system 210 can be any suitable braking system 210 as is known in the art, as long as the braking system 210 must ensure that the wind turbine 102 and 104 does not run away to damaging speeds in the event that the electrical grid is lost or that the generator 208 or its controls malfunction and the generator 208 is no longer capable of limiting the speed of the wind turbine rotor 124. The braking system 210 must also be capable of bringing the wind turbine 102 and 104 to a stop in a short period of time in the event of a fault or other problem with the wind turbine 102 and 104.

In one embodiment, the device 100 is made of a lightweight, durable material such as plastic, fiberglass, or the like and manufactured through common extruding and molding processes. Specifically, the drag-based wind turbine device 100 can be manufactured from heat-sealable plastic or polymers, such as polypropylene or acrylonitrile-butadiene-styrene (ABS), or any other suitable material as is known in the art, such as but not limited to, acrylic, polycarbonate, polyethylene, polyethylene terephthalate, polyvinyl chloride, polystyrene, etc. Generally, the device 100 is also manufactured from a material that is water resistant or waterproof, or the base component 114 and 116 and blades 108 and 110 comprise a coating that is water resistant or waterproof.

In yet another embodiment, the drag-based wind turbine device 100 comprises a plurality of indicia 212. The base component 114 and 116 and blades 108 and 110 of the device 100 may include advertising, a trademark, or other letters, designs, or characters, printed, painted, stamped, or integrated into the base component 114 and 116 and blades 108 and 110, or any other indicia 212 as is known in the art. Specifically, any suitable indicia 212 as is known in the art can be included, such as but not limited to, patterns, logos, emblems, images, symbols, designs, letters, words, characters, animals, advertisements, brands, etc., that may or may not be wind turbine, wind energy, or brand related.

As shown in FIG. 3, in use, when the two wind turbines 102 and 104 are placed in close proximity to each other, the combination of linear flow and drag from the two turbines 102 and 104 combines, such that the efficiency of both turbines 102 and 104 is increased. The separation 300 between the two turbines 102 and 104 should be kept as small as possible while allowing for appropriate machine and personnel safety. A separation 300 of approximately one to three feet is preferred. This close placement of turbines 102 and 104 may be adjusted as needed for efficiency.

In the coupled arrangement, the blades 108 and 110 of the two turbines 102 and 104 should rotate in opposite directions in order to achieve the desired increase in aerodynamic efficiency. Thus, each blade 108 of the first turbine 102 deflects incoming wind 302 to the other set of blades 110 from the second turbine 104 in a concave direction. Specifically, the surface 106 of the first turbine blades 108 are convex to ensure wind is always deflected toward the second turbine blades 110, wherein the wind 302 is then received by the concave side of the second turbine blades 110. Accordingly, drag from the first turbine 102 helps propel the second turbine 104. Further, the gap 300 between the two turbines 102 and 104 can be adjusted for different wind/current speeds, viscosities, compressibility, and densities for the best efficiency.

Additionally, in one embodiment, the wind turbines 102 and 104 in the coupled vortex arrangement should be oriented so that the line connecting the centerlines of the two wind turbines 102 and 104 is perpendicular to the prevailing energy wind direction.

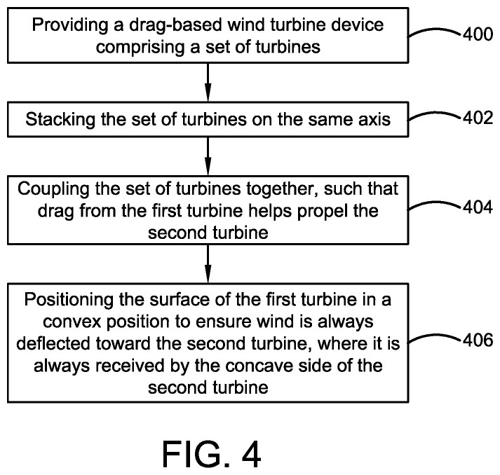

FIG. 4 illustrates a flowchart of the method of efficiently manipulating drag-based wind turbines. The method includes the steps of at 400, providing a drag-based wind turbine device comprising a set of turbines. The method also comprises at 402, stacking the set of turbines on the same axis. Further, the method comprises at 404, coupling the set of turbines together, such that drag from the first turbine helps propel the second turbine. Finally, the method comprises at 406, positioning the surface of the first turbine in a convex position to ensure wind is always deflected toward the second turbine, where it is received by the concave side of the second turbine.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “drag-based wind turbine device”, “wind turbine device”, “drag-based turbine device”, and “device” are interchangeable and refer to the drag-based wind turbine device 100 of the present invention.

Notwithstanding the forgoing, the drag-based wind turbine device 100 of the present invention can be of any suitable size and configuration as is known in the art without affecting the overall concept of the invention, provided that it accomplishes the above stated objectives. One of ordinary skill in the art will appreciate that the drag-based wind turbine device 100 as shown in FIGS. 1-4 is for illustrative purposes only, and that many other sizes and shapes of the drag-based wind turbine device 100 are well within the scope of the present disclosure. Although the dimensions of the drag-based wind turbine device 100 are important design parameters for user convenience, the drag-based wind turbine device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A drag-based wind turbine device that provides a user with a more efficient wind turbine that captures wind energy more effectively, the drag-based wind turbine comprising:
a first wind turbine; and
a second wind turbine;
wherein the first wind turbine and the second wind turbine are stacked and coupled together on a main shaft;
wherein drag from the first wind turbine helps propel the second wind turbine;
wherein a surface of the first wind turbine is convex to ensure wind is always deflected toward the second wind turbine; and
further wherein the wind is then received by a concave side of the second wind turbine.

2. The drag-based wind turbine device of claim 1, wherein the first wind turbine and the second wind turbine comprise a main shaft which rotates about a vertical axis.

3. The drag-based wind turbine device of claim 2, wherein the first wind turbine comprises a first base component with three blades and the second wind turbine comprises a second base component with three blades.

4. The drag-based wind turbine device of claim 3, wherein the first and the second base components are secured to the main shaft.

5. The drag-based wind turbine device of claim 4, wherein each blade is attached to the main shaft with a pair of blade arms via a pinned connection.

6. The drag-based wind turbine device of claim 5, wherein the main shaft is supported at a lower end by a drive train housing and at an upper or lower end by a bearing, which is then supported by a set of guy cables.

7. The drag-based wind turbine device of claim 6, wherein the three blades of the first base component would rotate in a convex direction, while the three blades of the second base component would rotate in a concave direction.

8. The drag-based wind turbine device of claim 7, wherein a second set of wind turbines is secured to the main shaft.

9. The drag-based wind turbine device of claim 7, wherein each of the three blades of the first and the second base components are arranged in a horizontal and sloping manner.

10. The drag-based wind turbine device of claim 9, wherein each of the three blades comprise a straight surface end and a curved surface end, wherein the curved surface end curves down toward the base component.

11. The drag-based wind turbine device of claim 10 further comprising a braking system for braking the drag-based wind turbine device, when needed.

12. The drag-based wind turbine device of claim 11 further comprising a plurality of indicia.

13. A drag-based wind turbine device that provides a user with a more efficient wind turbine that captures wind energy more effectively, the drag-based wind turbine device comprising:
a first wind turbine comprising a first base component with three blades; and
a second wind turbine comprising a second base component with three blades;
wherein the first wind turbine and the second wind turbine are stacked and coupled together on a main shaft which rotates about a vertical axis;
wherein the first and the second base components are secured to the main shaft with a pair of blade arms via a pinned connection;
wherein the three blades of the first base component would rotate in a convex direction, while the three blades of the second base component would rotate in a concave direction;
wherein each of the three blades of the first and the second base components are arranged in a horizontal and sloping manner;
wherein a surface of the first wind turbine is convex to ensure wind is always deflected toward the second wind turbine;
wherein the wind is then received by a concave side of the second wind turbine;
wherein the first and the second wind turbines are placed in close proximity to each other; and
further wherein drag from the first wind turbine helps propel the second wind turbine.

14. The drag-based wind turbine device of claim 13, wherein a gap between the first and the second wind turbines can be adjusted for different wind/current speeds, viscosities, compressibility, and densities for the best efficiency.

15. The drag-based wind turbine device of claim 13, wherein each of the three blades comprise a straight surface end and a curved surface end, wherein the curved surface end curves down toward the base component.

16. The drag-based wind turbine device of claim 13 further comprising a braking system for braking the drag-based wind turbine device, when needed.

17. The drag-based wind turbine device of claim 13, wherein a second set of wind turbines is secured to the main shaft.

18. The drag-based wind turbine device of claim 13, wherein the main shaft is supported at a lower end by a drive train housing and at an upper end by a bearing, which is then supported by a set of guy cables.

19. The drag-based wind turbine device of claim 13 further comprising a plurality of indicia.

20. A method of efficiently manipulating drag-based wind turbines, the method comprising the following steps:
providing a drag-based wind turbine device comprising a set of turbines;
stacking the set of turbines on the same axis;
coupling the set of turbines together, such that drag from the first turbine helps propel the second turbine; and
positioning the surface of the first turbine in a convex position to ensure wind is always deflected toward the second turbine, where it is received by the concave side of the second turbine.
